(19) United States
(12) Patent Application Publication
(10) Pub. No.: US 2016/0181750 A1
(43) Pub. Date: Jun. 23, 2016

(54) Electrical Extension Cord with Remote Power Control

(71) Applicant: Tan Trinh, San Francisco, CA (US)

(72) Inventor: Tan Trinh, San Francisco, CA (US)

(21) Appl. No.: 14/973,906

(22) Filed: Dec. 18, 2015

Related U.S. Application Data
(60) Provisional application No. 62/093,511, filed on Dec. 18, 2014.

(51) Int. Cl. H01R 27/02; H01R 13/713; H01R 25/00; H01H 23/24; H01R 24/30; H01R 13/717; H01H 13/14

(52) U.S. Cl. CPC H01R 27/02; H01R 13/717; H01R 13/7135; H01H 13/14; H01H 23/24; H01R 24/30; H01R 25/00; H01H 2231/032; H01R 2107/00

(57) ABSTRACT

An electrical extension cord with a remote power control is provided. The extension cord includes an elongated electrical cord having a first end and a second end. A plug is located at the first end of the elongated electrical cord and a power box is located at the second end of the elongated electrical cord. The power box comprises one or more electrical power switches for selectively providing power to one or more power outlets. The elongated electrical cord further comprises a housing having the one or more power outlets disposed between the first end and the second end of the elongated electrical cord.

### CROSS REFERENCE TO RELATED APPLICATION

This application claims the benefit of U.S. Provisional Application No. 62/093,511 filed on Dec. 18, 2014. The above identified patent application is herein incorporated by reference in its entirety to provide continuity of disclosure.

### BACKGROUND OF THE INVENTION

The present invention generally relates to an extension cord. More specifically, the present invention relates to an extension cord having a remote power control with one or more electrical power switches for selectively providing electrical power to an outlet on the extension cord.

The use of multiple electrical devices, such as appliances and electronics, creates a need for multiple electrical outlets for plugging in the power cords of the various devices. Electrical power strips, which typically contain four or more individual outlets, are commonly used to supply the AC power to multiple devices. The electrical power strip provides a convenient and central mechanism for plugging in multiple peripheral devices. Along with worldwide applications of electrical appliances, extension cords become essential components to electrical appliances, such as sockets and plugs. Conventional sockets and plugs are generally independent components with a single function. People must resort to multi-functional sockets to satisfy requirements of users when a plurality of electrical devices need a socket at the same time.

Conventional extension cords are limited since they provide outlets at the end of the cord and a switch to power the outlets on the housing which contains them. It can be dangerous for people to use certain electric equipment and other equipment connected to a single power strip. To fully cut the power from the equipment, a user has to unplug the cord from an outlet located on the power strip, which can be time consuming and highly inconvenient. Likewise, when working in any space, it can be problematic to remove a plug from an outlet when in an area that is remote to the outlet.

Devices have been disclosed in the prior art that relate to extension cords having control switches. These include devices that have been patented and published in patent application publications. These devices generally relate to an extension cord having multiple outlets with a control switch thereon. For example, U.S. Pat. No. 2,979,624, U.S. Pat. No. 8,129,858, and U.S. Pat. No. 7,701,086 relate to remote controlled extension cords attached to a base and a plug. Other patents relate to relate to extension cords having one or more sockets with a plug on one end, such as U.S. Pat. No. 7,210,960 and U.S. Pat. No. 5,238,424.

These prior art devices have several known drawbacks. These devices still have the control switches at a central location on a housing, such as a power strip, that includes the power outlets, so as to enable a user to power the outlets on and off. Thus, normally, a user has to find the power strip and operate the power switch thereon. Such devices may not be suited for providing power to power tools because the centralized location of the power switch and outlets does not allow a user to turn off equipment easily or within reach in a remote area in which a user is working. However, the present invention provides users easy access to the control switch since it is separate from the outlets and is moveable to a location near wear the user is working with electrical appliances.

In light of the devices disclosed in the prior art, it is submitted that the present invention substantially diverges in design elements from the prior art and consequently it is clear that there is a need in the art for an improvement to existing extension cords. In this regard the instant invention substantially fulfills these needs.

### SUMMARY OF THE INVENTION

In view of the foregoing disadvantages inherent in the known types of extension cords now present in the prior art, the present invention provides an electrical extension cord having a remote power control wherein the same can be utilized for providing convenience to a user when controlling the power running to the outlets of an extension cord from a remote location. The present system includes an elongated electrical cord having a first end and a second end. The electrical cord includes a housing between the first end and the second end that includes one or more power outlets for receiving the plugs of numerous electrical devices. The first end includes a plug having connection prongs on one end thereof and the second end includes a remote power control in electrical communication with the housing. The power control box includes one or more electrical power switches for selectively providing power to the one or more power outlets. The housing further includes one or more indicator light corresponding to the one or more electrical power switches that are configured to illuminate when the one or more power switches are actuated into an on configuration, thus signaling to the user that the power flowing to an outlet is on or off.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the electrical extension cord according to one embodiment of the present invention.

FIG. 2 shows a close-up view of the remote power box of the electrical extension cord according to one embodiment of the present invention.

FIG. 3 shows a close-up view of the power outlet housing of the electrical extension cord according to one embodiment of the present invention.

### DETAILED DESCRIPTION OF THE INVENTION

Reference is made herein to the attached drawings. Like reference numerals are used throughout the drawings to depict like or similar elements of the electrical extension cord. For the purposes of presenting a brief and clear description of the present invention, the preferred embodiment will be discussed as used for remotely controlling one or more power outlets disposed on an extension cord. The figures are intended for representative purposes only and should not be considered to be limiting in any respect.

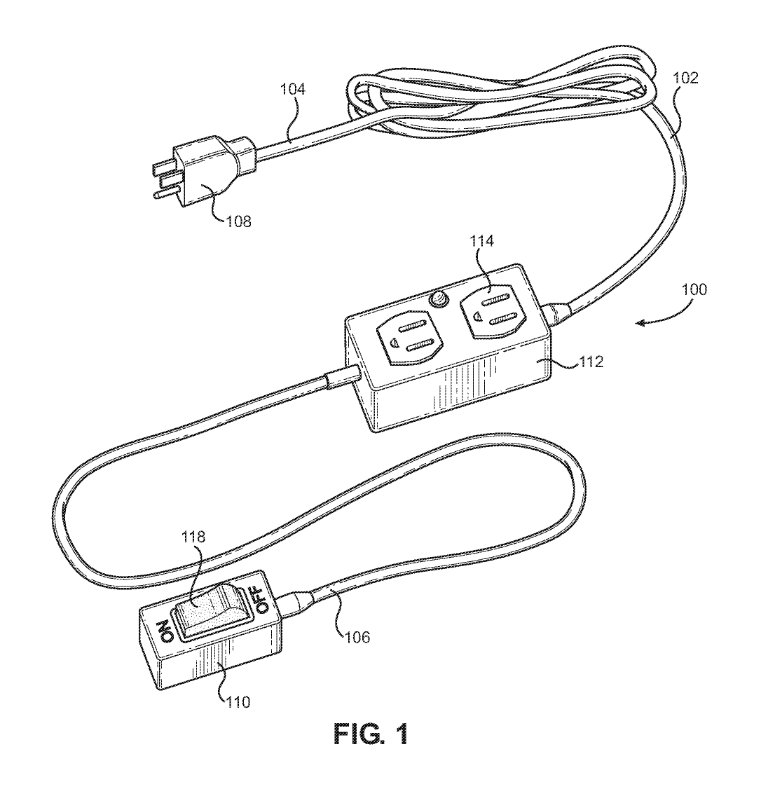

Referring now to FIG. 1, there is shown a perspective view of the electrical extension cord according to one embodiment of the present invention. The electrical extension cord 100 of the present invention includes a remote power control for remotely controlling the power to power outlets on the extension cord, thereby eliminating the need to unplug a device from a wall outlet to cut the power. The electrical extension cord 100 controls the flow of electricity to equipment with the actuation of an electrical power switch. The device allows an individual to control the power flowing to an electronic device or appliance connected to the extension cord at a location remote to an wall outlet or receptacle, thereby enabling a user to cut the power to the device or appliance without having to walk over to an outlet to remove the extension cord plug therefrom or having to actuate the power switch on the outlet itself.

The electrical extension cord 100 comprises an elongated electrical cord 102 having a first end 104 and a second end 106. The elongated electrical cord 102 is a flexible electrical power cable with a plug 108 having one or more connection prongs at one end thereof. Preferably, the plug 108 is located at the first end 104 of the elongated electrical cord 102. The plug 108 is adapted to engage with an electrical outlet and/or receptacle via the connection prongs extending therefrom. A housing 112 is disposed between the first end 104 and the second end 106 of the elongated electrical cord 102. The housing 112 includes one or more power outlets 114 for receiving a plug therein. In one embodiment, the housing 112 includes a rotatable reel mounted within a hollow housing 112 for receiving the extension cord 102 in a wound configuration.

A remote power control box 110 is located at the second 106 end of the elongated electrical cord 102. The power control box 110 comprises one or more electrical power switches 118 for controlling the flow of electricity through the extension cord. The power control box 110 is in electrical communication with the housing 112 and is adapted to selectively provide electricity to the power outlet 114. The one or more switches 118 are configured to selectively control the power running to the one or more power outlets 114 on the housing 112. In the depicted embodiment, the power control box 110 comprises an electrical power switch adapted to control the power to both power outlets 114. In another embodiment, the power control box 110 comprises two or more power switches, each in electrical communication with one corresponding power outlet. Each switch is configured to control the corresponding outlet, thereby enabling a user to selectively control the power of an outlet on the extension cord. In one embodiment, the electrical power switch comprises a toggle switch. In alternative embodiments, the electrical power switch comprises another type of electrical switch, such as a pushbutton switch or a selector switch.

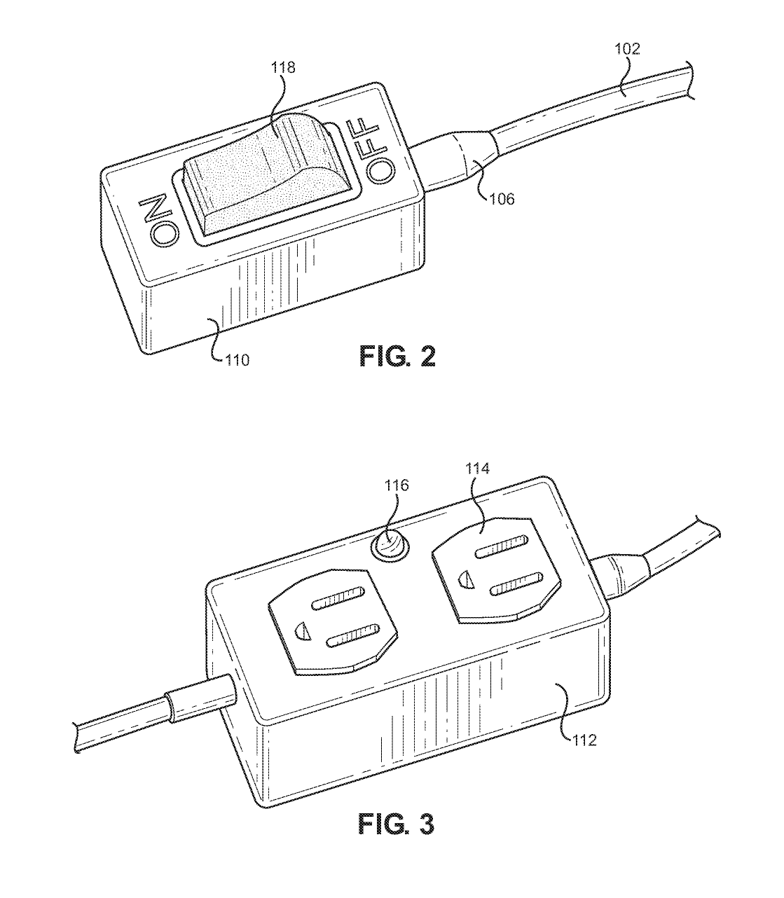

Referring now to FIG. 2, there is shown a close-up view of the remote power control box according to one embodiment of the present invention. The remote power control box 110 is located at the second end 106 of the elongated electrical cord 102. In one use, a user can connect the elongated electrical cord into an outlet or a receptacle via the plug and then plug equipment into the one or more power outlets on the housing. The user can then bring the power control box 110 to an area in which he or she is working and using the equipment that is plugged into the housing. The user can then use the power switch 118 to remotely control the flow of electricity to the equipment without having to return to the wall outlet or traditional extension cord connection and unplug the equipment or without having to locate the power switch on the outlet housing to cut power. The present invention, therefore, provides a user convenience when using electrical devices, such as power tools, lamps, heaters, fans, vacuums, and the like.

Referring now to FIG. 3, there is shown a close-up view of the housing according to one embodiment of the present invention. The housing further includes an indicator light 116 in electrical communication with the one or more electrical power switches. In the depicted embodiment, the indicator light is an LED light. In alternative embodiments, the indicator light 116 includes another type of light, such as an incandescent, fluorescent, or halogen light. The light turns on or illuminates when the power switch 118 is actuated into an on configuration and the light turns off when the power switch 118 is actuated into an off configuration. In alternative embodiments, the housing comprises one or more indicator lights that correspond to the one or more electrical power switches. Thus, when a power switch is actuated into an on configuration to power an outlet, an indicator light corresponding that power switch is illuminated, thereby providing a signal to the user that the outlet has power running to it.

In one embodiment, the housing further comprises a circuit breaker such as a ground fault circuit interrupter (GFCI), for detecting a fault condition and interrupting current flow in order to protect the electrical circuit created by the extension cord from damage caused by overload or short circuit. A fault condition occurs when two or more electrical conductors in an electrical circuit contact ground and/or each other or when as current flows through an unintended path such as through water or a person. In another embodiment, the housing is a ground fault circuit interrupter (GFCI) outlet box with a power-light indicator. An individual can plug the cord of the present invention into a wall outlet and/or receptacle and plug an electronic device into the GFCI outlet box. Power can be supplied to the electronic device with actuation of the one or more power switches.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An extension cord, comprising:
an elongated electrical cord having a first end and a second end;
a housing disposed between the first end and the second end of the elongated electrical cord, wherein the housing includes one or more power outlets;
a plug disposed at the first end of the elongated electrical cord, wherein the plug includes connection prongs on one end thereof; and
a power control box disposed at the second end of the elongated electrical cord comprising one or more electrical power switches thereon, wherein the one or more power switches are actuable into an on configuration and an off configuration for controlling the power to the one or more power outlets.

2) The extension cord of claim 1, wherein the housing further comprises one or more indicator lights wherein each of said one or more indicator lights corresponds to one of said one or more power switches.

3) The extension cord of claim 1, wherein the housing further comprises an interior volume having a rotatable wheel therein for retracting and extending the extension cord from the housing.

4) The extension cord of claim 3, wherein the rotatable wheel comprises an actuator for retracting and extending the extension cord from the housing.

5) The extension cord of claim 4, wherein the actuator is a motor.

6) The extension cord of claim 1, wherein the housing further comprises a circuit breaker.

7) The extension cord of claim 6, wherein the circuit breaker comprises a ground fault circuit interrupter.

8) The extension cord of claim 1, wherein the one or more power outlets are ground fault circuit interrupter receptacles.

9) The extension cord of claim 1, wherein the elongated electrical cord is a cable wire.

10) The extension cord of claim 9, wherein the cable wire is composed of a flexible plastic material.

11) The extension cord of claim 10, wherein the flexible plastic material is polyvinyl chloride.

12) The extension cord of claim 1, wherein the plug includes three connection prongs thereon.

13) The extension cord of claim 1, wherein the plug includes two connection prongs thereon.

14) The extension cord of claim 1, wherein the one or more electrical power switches comprise toggle switches.

15) The extension cord of claim 1, wherein the one or more electrical power switches comprise pushbutton switches.

16) The extension cord of claim 1, wherein the one or more electrical power switches comprise selector switches.
